(19) United States
(12) Patent Application Publication
(10) Pub. No.: US 2025/0178891 A1
(43) Pub. Date: Jun. 5, 2025

(54) PROCESS FOR CO-PRODUCING AMMONIA AND METHANOL WITH REDUCED CARBON

(71) Applicant: Topsoe A/S, Kgs. Lyngby (DK)

(72) Inventor: Per Juul Dahl, Vedbæk (DK)

(73) Assignee: Topsoe A/S, Kgs. Lyngby (DK)

(21) Appl. No.: 18/842,733

(22) PCT Filed: Mar. 13, 2023
(86) PCT No.: PCT/EP2023/056309

§ 371 Date: Aug. 29, 2024

(30) Foreign Application Priority Data
Mar. 21, 2022 (DK) PA202200227

(51) Int. Cl. C01B 3/02; C01C 1/04

(52) U.S. Cl. CPC C01B 3/025; C01C 1/0405; C01B 2203/0244; C01B 2203/0283; C01B 2203/042; C01B 2203/046; C01B 2203/0475; C01B 2203/061; C01B 2203/068; C01B 2203/0827; C01B 2203/1235

(57) ABSTRACT

Process for the co-production of ammonia and methanol with reduced carbon dioxide emission comprising the steps of (a) providing a hydrocarbon feed stock; (b) preheating the hydrocarbon feed stock in a fired heater and/or a reformer waste heat section; (c) steam reforming the preheated hydrocarbon feed stock in at least one steam re-former to a raw synthesis gas comprising hydrogen and carbon oxides where the module M is <2.05; (d) splitting the raw synthesis gas into a first and second stream; (e) passing the first stream of the raw synthesis gas to water gas shift section comprising one or more shift reactors for generating a shifted synthesis gas; (f) passing the shifted synthesis gas to a carbon dioxide removal section for generating a carbon dioxide depleted synthesis gas; (g) cleaning the carbon depleted synthesis gas in a cleaning unit to a cleaned synthesis gas comprising hydrogen or hydrogen and nitrogen, optionally adding nitrogen to the cleaned synthesis gas to generate an ammonia synthesis gas with a molar ratio of hydrogen to nitrogen of between 2.9-3.1; (h) converting the ammonia synthesis gas to ammonia; and (i) passing the second stream of the raw synthesis gas to a cooling and water separation section to generate a water depleted synthesis gas; (j) adding a part of the of the carbon depleted synthesis gas from step (f) to the water depleted synthesis gas to generate a methanol synthesis gas with a module M>1.95; (k) converting the methanol synthesis gas in at least one methanol reactor to methanol and withdrawing a raw methanol product and a purge gas stream containing unconverted methanol synthesis gas; wherein the purge gas stream from step (k) is added to the first stream of the raw synthesis gas upstream to step (e) and/or to the steam reforming in step (c).

The present invention relates to a process for co-producing ammonia and methanol with reduced carbon emission. In particular, the invention employs a common reforming section and where the resulting synthesis gas is split and passed into an ammonia synthesis section and a methanol synthesis section.

Co-production of ammonia and methanol is known from e.g. applicant's U.S. Pat. No. 8,692,034. A CO₂ pressure swing adsorption (CO₂ PSA) off-gas stream is recycled to the primary reformer together with an off-gas fuel stream obtained from ammonia synthesis. The partly reformed gas from the primary reformer is further reformed in an air-blown secondary reforming stage.

U.S. Pat. No. 8,303,923 also belonging to the applicant, describes a process for co-producing ammonia and methanol from a hydrocarbon feed gas. The off-gas fuel containing hydrogen, nitrogen and methane from the ammonia synthesis reactor is returned to the primary reforming stage.

Currently, purge gas from the methanol synthesis is send through a hydrogen recovery unit and the hydrogen rich stream is used to adjust the module inlet the methanol synthesis to >1.98 and the off gas is used as fuel.

It would be desirable to reduce carbon emission in the known processes for co-production of ammonia and methanol.

In the standard solution purge gas from the methanol synthesis is send through a hydrogen recovery unit and the hydrogen rich stream is used to adjust the module inlet the methanol synthesis to >1.98 and the off gas is used as fuel.

Hydrogen rich fuel to replace hydrocarbon fuel for the reforming section and utilities are taken from the make-up gas to the ammonia synthesis loop or from CO₂ depleted gas from the CO₂ removal unit. These flow can be adjusted to meet the allowable CO₂ emission per tons of methanol and ammonia product.

It has been found that carbon dioxide emission can be reduced, when passing a purge gas from the methanol synthesis stage to the inlet of the reforming section and/or to a shift stage in the ammonia synthesis section and replace hydrocarbon fuel for the reforming section with hydrogen rich fuel split from the ammonia synthesis gas.

The limitation for reducing CO₂ emission via the flue gas can be calculated as the ammonia production divided by the total production, multiplied with the methane slip outlet the reforming unit plus 5%. The condition for this is that the ammonia production comprise minimum 20% of the total production. This enables less than 2% to 5% moles of carbon of the moles of carbon in the combined natural gas feed plus fuel to the process. The percent depends on the product ratio, high methanol production gives low carbon emission.

The present invention provides a process for the co-production of ammonia and methanol with reduced carbon dioxide emission comprising the steps of
(a) providing a hydrocarbon feed stock;
(b) preheating the hydrocarbon feed stock in a fired heater and/or reformer waste heat section;
(c) steam reforming the preheated hydrocarbon feed stock in at least one steam reformer to a raw synthesis gas comprising hydrogen and carbon oxides where the module M is <2.05;
(d) splitting the raw synthesis gas into a first and second stream;
(e) passing the first stream of the raw synthesis gas to water gas shift section comprising one or more shift reactors for generating a shifted synthesis gas;
(f) passing the shifted synthesis gas to a carbon dioxide removal section for generating a carbon dioxide depleted synthesis gas;
(g) cleaning the carbon depleted synthesis gas in a cleaning unit to a cleaned synthesis gas comprising hydrogen or hydrogen and nitrogen, optionally adding nitrogen to the cleaned synthesis gas to generate an ammonia synthesis gas with a molar ratio of hydrogen to nitrogen of between 2.9-3.1;
(h) converting the ammonia synthesis gas to ammonia;
and
(i) passing the second stream of the raw synthesis gas to a cooling and water separation section to generate a water depleted synthesis gas;
(j) adding a part of the of the carbon depleted synthesis gas from step (f) to the water depleted synthesis gas to generate a methanol synthesis gas with a module M>1.95;
(k) converting the methanol synthesis gas in at least one methanol reactor to methanol and withdrawing a raw methanol product and a purge gas stream containing unconverted methanol synthesis gas;
wherein the purge gas stream from step (k) is added to the first stream of the raw synthesis gas upstream to step (e) and/or to the steam reforming in step (c)

In an embodiment of the invention the carbon emission from the synthesis gas generation is further reduced by using carbon dioxide depleted synthesis gas from step (f) and/or a part of cleaned synthesis gas from step (g) as fuel in the fired heater in step (b).

For the purposes of the present application, the term “steam reforming” shall be interpreted broadly and means a reforming step in which the catalytic reaction CH₄+H₂O+heat↔CO+3H₂ takes place; for instance, traditional steam methane reforming (SMR), autothermal reforming (ATR) and two step reforming.

The steam reforming is preferably performed in an autothermal reformer (ATR) at a steam/carbon (S/C) molar ration of below 1 in the feed gas, preferably at a ratio of about 0.6. Thereby less steam is carried in the process with attendant reduction of e.g. equipment size and operation costs.

The S/C ratio is the molar ratio of all steam added to the reforming, i.e. steam which may have been added to the reforming via the hydrocarbon feedstock gas, oxygen feed, by addition to the ATR and the carbon in hydrocarbons in the hydrocarbon feedstock gas (hydrocarbon feed) to the reforming section on a molar basis.

In an embodiment of the invention, the hydrocarbon feed stock from step (a) is prereformed in a preformer upstream the fired heater in step (b).

The use of prereforming in a prereformer conveys some important advantages. In a prereformer, a hydrocarbon feed gas will, together with steam, and potentially also hydrogen and/or other components such as carbon dioxide, undergo prereforming in a temperature range of ca. 350-550° C. to convert higher hydrocarbons as an initial step in the process. This removes i.a. the risk of carbon formation from higher hydrocarbons on catalyst in the subsequent process steps.

In an embodiment of the invention, the process comprises desulfurization of the hydrocarbon feedstock, e.g. prior to conducting a prereforming step and/or prior to conducting the steam reforming. Suitably, as is well known in the art, the hydrocarbon feedstock is passed through a hydrogenation step and then desulfurization for removal of sulfur and other impurities impairing the performance of downstream catalysts. In a particular embodiment, hydrogen produced in the process may be used in the hydrogenation.

The synthesis gas used for methanol production is normally described in terms of said module M, since the synthesis gas is in balance for the methanol reaction when M=2. In typical synthesis gases for methanol production, such as synthesis gas produced by steam reforming, the synthesis gas will contain some excess hydrogen resulting in modules slightly above 2, for instance 2.05 or 2.1.

For methanol synthesis (step k), the second synthesis gas stream is adapted to have a module M=(H₂—CO₂)/(CO+CO₂) 1.8-2.1 or 1.9-2.1, preferably 2. This value of M (molar basis) of 2 is particularly suitable for the subsequent methanol conversion.

For ammonia synthesis (step h), the ammonia synthesis gas stream rich in hydrogen and nitrogen is adapted, e.g. by nitrogen wash step, so that the molar ratio of hydrogen to nitrogen is 2.9 to 3.1, preferably 3 which is required for the subsequent ammonia conversion.

In an embodiment of the invention, the cleaning step (g) of the carbon depleted synthesis gas is conducted in a purification unit selected from: a pressure swing adsorption (PSA) unit, and a cryogenic separation unit, preferably nitrogen wash unit. This step produces a cleaned gas which is practically inert free when used for ammonia synthesis.

In an embodiment according to the invention, part of the carbon dioxide depleted stream from step (f) is used as fuel in step (b)

In an embodiment according to the invention, part of the cleaned gas stream from step (g) is used as fuel in step (b)

In an embodiment according to the invention, the moles of carbon in the flue gas from step (b) can be reduced to be less than between 2% to 5% moles of carbon present in the combined feed plus fuel natural gas. The percentage depends on the product ratio. Higher methanol production gives lower carbon content in the flue gas.

In an embodiment according, the nitrogen for a nitrogen wash in cleaning step (g) is provided by an air separation unit (ASU), and wherein the ASU also provides an oxidant gas for the ATR.

In an embodiment of the invention, preheating of the hydrocarbon feedstock is conducted, preferably in one or more fired heaters

A fired heater normally uses natural gas as fuel for burning and thus generating the energy required for preheating.

As already mentioned hereinbefore, when cycling purge gas from the methanol synthesis in step (k) to the steam reforming process in step (c) and/or to the raw synthesis gas upstream step (e), the carbon footprint is significantly reduced, since excess carbon and methane in the second stream is passed as feed to the reforming step (c) or to the first stream from where the CO content will generate more H2 and thereby reduce the amount of the hydrocarbon feed and from where after all CO2 will be captured resulting in reduced CO2 emission via flue gas

In addition, additional off-gas streams produced in the carbon dioxide removal step (f) and/or a part of the cleaned ammonia synthesis gas can be used as fuel in the fired heater(s) in step (b), which additional reduces the carbon dioxide emission from the process.

In summary, the preferred embodiments of the invention are:
1. Process for the co-production of ammonia and methanol with reduced carbon dioxide emission comprising the steps of
(a) providing a hydrocarbon feed stock;
(b) preheating the hydrocarbon feed stock in a fired heater and/or reformer waste heat section;
(c) steam reforming the preheated hydrocarbon feed stock in at least one steam reformer to a raw synthesis gas comprising hydrogen and carbon oxides where the module M is <2.05;
(d) splitting the raw synthesis gas into a first and second stream;
(e) passing the first stream of the raw synthesis gas to water gas shift section comprising one or more shift reactors for generating a shifted synthesis gas;
(f) passing the shifted synthesis gas to a carbon dioxide removal section for generating a carbon dioxide depleted synthesis gas;
(g) cleaning the carbon depleted synthesis gas in a cleaning unit to a cleaned synthesis gas comprising hydrogen or hydrogen and nitrogen, optionally adding nitrogen to the cleaned synthesis gas to generate an ammonia synthesis gas with a molar ratio of hydrogen to nitrogen of between 2.9-3.1;
(h) converting the ammonia synthesis gas to ammonia;
and
(i) passing the second stream of the raw synthesis gas to a cooling and water separation section to generate a water depleted synthesis gas;
(j) adding a part of the of the carbon depleted synthesis gas from step (f) to the water depleted synthesis gas to generate a methanol synthesis gas with a module M>1.95;
(k) converting the methanol synthesis gas in at least one methanol reactor to methanol and withdrawing a raw methanol product and a purge gas stream containing unconverted methanol synthesis gas;
wherein the purge gas stream from step (k) is added to the first stream of the raw synthesis gas upstream to step (e) and/or to the steam reforming in step (c)
2. Process according to embodiment 1, wherein the steam reforming in step (c) is performed in an autothermal reactor.
3. Process according to embodiment 2, wherein the autothermal reactor is operated on pure oxygen.
4. Process according to any one of the preceding embodiments, wherein the second synthesis gas stream is adapted to have a module M=(H₂—CO₂)/(CO+CO₂) 1.8-2.1, 1.9-2.1, such as 2.
5. Process according to any one of the preceding embodiments, wherein the cleaning step (g) of the carbon depleted synthesis gas is conducted in a purification unit selected from: a pressure swing adsorption (PSA) unit, and a cryogenic separation unit.
6. Process according to any one of the preceding embodiments, wherein the cleaning step (g) of the carbon depleted synthesis gas is conducted in a nitrogen wash unit.
7. Process according to any one of the preceding embodiments, wherein part of the carbon dioxide depleted stream from step (f) is used as fuel in step (b).
8. Process according to any one of the preceding embodiments, wherein part of the cleaned gas stream from step (g) is used as fuel in step (b).
9. Process according to any of the preceding embodiments, wherein nitrogen for a nitrogen wash in cleaning step (g) and/or nitrogen for Hydrogen/Nitrogen molar ratio control of the stream inlet the ammonia synthesis (h) is provided by an air separation unit.
10. Process according to claim 9, wherein the Hydrogen/Nitrogen molar ratio in the stream to the ammonia synthesis (h) is between 2.9 and 3.1
11. Process according to embodiment 3, wherein the pure oxygen is provided form an air separation unit.
12. Process according to claim any one of the preceding embodiments, wherein a part of the carbon dioxide depleted synthesis gas from step (f) and/or part of the cleaned synthesis gas from step (g) is used as fuel in the fired heater rand/or the reformer in step (b).

### BRIEF DESCRIPTION OF THE DRAWINGS

FIG. 1 shows a process scheme according to a specific embodiment of the invention for producing methanol and ammonia.

### Process Steps

A: Autothermal Reformer
B: Shift section comprising one or more shift reactors
C: CO₂ removal unit with optionally off-gas outlet
D: Synthesis gas cleaning unit producing either a pure hydrogen stream or a pure hydrogen plus nitrogen.
E: Ammonia synthesis
F: Cooling and water separation section
G: Methanol synthesis
H: Fired heater
I: Prereformer
K: Air separation unit

Process streams
1: Hydrocarbon feed
2, 3 and 4: Reformed gas
5: Shifted synthesis gas
6, 7, 20 and 21: CO₂ depleted synthesis gas
8 and 9: Pure hydrogen or pure hydrogen and nitrogen gas
10: Ammonia
22 and 23: Hydrogen rich gas
50 and 51: CO₂
80: Nitrogen
40: Water depleted synthesis gas
41: Methanol synthesis gas with module M>1.95
42: Methanol.
30, 31, 32: Not converted gas from the methanol synthesis, ie purge gas, send to A and/or B
35: CO₂ depleted purge gas.
90, 91 and 94: Off gases to be used as fuel
92, 93 and 95: Hydrogen rich gases to be used as fuel

### DETAILED DESCRIPTION

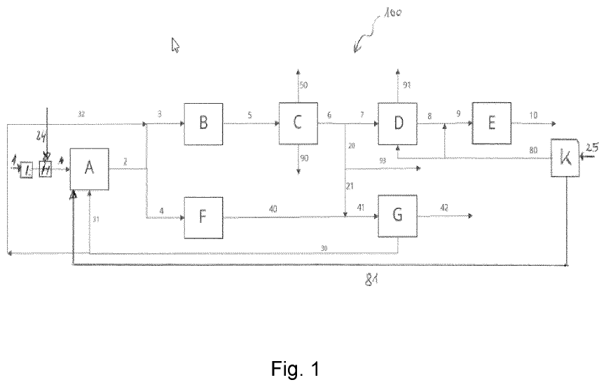

With reference to FIG. 1, a process/plant 100 is shown comprising a reforming stage, methanol synthesis stage, and ammonia synthesis stage. In the reforming stage, a hydrocarbon feedstock 1 such as natural gas is preheated in a fired heater H, prior to being prereformed in prereformer I under the addition of steam (not shown). From the prereforming unit I, the prereformed gas is preheated again in the fired heater H prior to being subjected to oxygen blown autothermal reforming (ATR) in ATR unit A. The fired heater H generates heat from the burning of a hydrocarbon fuel 60 such as natural gas and a fuel gas 24 which combines fuel gases of off-gases (90, 91, 93) from downstream units such as synthesis gas cleaning purification unit D and the CO₂ removal unit (C) or are part of the carbon dioxide depleted synthesis gas from CO₂ removal unit (C). An air separation unit (K) receives air stream 25 and produces an oxygen stream 81 which is used in the ATR unit A, as well as nitrogen stream 80 which is optionally split in nitrogen streams 81 and 82, where 81 is send to gas cleaning unit D in case this comprise a nitrogen wash and 82 is used for downstream H2/N2 ratio control of the ammonia synthesis gas stream 9. The gas cleaning unit D can either comprise a pressure swing unit or a nitrogen wash unit. In case of pressure swing unit all nitrogen stream 80 is mixed in downstream unit D.

From the ATR unit A, a common reformed gas stream 2 is produced which is split into first reformed gas stream 3 and second reformed gas stream 4.

The first reformed gas stream 3 is subjected to high and subsequent low temperature shift in shift section B. Shifted synthesis gas 5 is passed to a CO₂-removal unit C, such as an amine wash unit. From this unit a CO₂-rich stream 50 is send for use or storage outside plant 100, an optional off gas 90 is used as part fuel in fired heater H, and the CO₂-depleted synthesis gas 6 is split in a first CO2 depleted synthesis gas 7 and a second CO2 depleted gas 20. the first CO2 depleted synthesis gas 7 is send to a cleaning unit D for generation of a practically pure hydrogen or hydrogen plus nitrogen stream 8. The off-gas stream 91 from unit D is used as fuel in H. If Cleaning unit D comprise a nitrogen wash then it is supplied with nitrogen 82 from ASU K. The pure hydrogen or hydrogen plus nitrogen stream 8 is mixed with nitrogen stream 81 and passed in stream 9 to the ammonia synthesis unit E. The molar ratio of hydrogen to nitrogen in stream 9 is adjusted to be between 2.9 and 3.1, as required in the ammonia synthesis E. Part of stream 9 can be split into Hydrogen rich fuel, stream 94, to be used in H. After this optional split the remaining stream is send to unit E. Ammonia is withdrawn from synthesis unit E in stream 10.

The second synthesis gas stream 4 is passed to cooling and water separation unit F. A cooled and water depleted synthesis gas stream 40 is withdrawn from unit F. The second CO2 depleted gas 20 is optionally split in 93 which is used as hydrogen rich fuel in H and stream 21. Stream 21 is added to the water depleted synthesis gas 40 in an amount to achieve a module M, i.e. (CO—CO2)/(H2-CO2) of >1.95 in the resulting methanol synthesis gas stream 41. The methanol synthesis gas 41 is send to the methanol synthesis G. A stream of raw methanol 42 is withdrawn from unit G and sent to further processing as known in the art. Unconverted synthesis gas from the methanol synthesis is circulated in purge gas stream 30 to the autothermal reformer A, via split stream 31, or to the shift section B, via split stream 32, or to both A and B.

### Example

SynCOR™ is the name for the most OPEX and CAPEX efficient synthesis gas generation unit comprising feed preheat in a fired heater, prereforming, oxygen blown autothermal reforming at molar steam/carbon ratio below 1.0 preferably 0.6, waste heat boiler and connected steam drum. SynCOR™ can be designed for large scale single line capacities, considerably larger than practically possible with tubular reformers. For this reason, SynCOR™ can be used as Syngas hub, delivering syngas for multiple products such as Fisher Tropsh GTL, Gasoline, Methanol, Ammonia, Hydrogen, Carbon monoxide etc.

SynCOR™ plus is the name for an ammonia and methanol co production process where SynCOR™ is used as the common synthesis gas generator

Table 1 compares the main parameters for a specific standard SynCOR™ plus layout producing 5000 MTPD Methanol and 3000 MTPD ammonia.

In the ‘Purge gas to shift case’ all the purge gas from the methanol synthesis G is added to the reformed gas 3 inlet the shift unit B via stream 30 and 31. Only off gas from unit C and D, stream 90 and 91 are used as fuel in H, the remaining fuel to H is natural gas, 60.

It is seen that the ‘Purge gas to shift case’ reduces the total natural gas consumption and the CO2 emission in the flue is reduced by more than 15%. The introduction of the invented new way of handling the methanol synthesis purge gas is significant and therefore a much better starting point for making blue products.

In the ‘SynCOR™ plus 90% Blue case’ all the purge gas 30 is added to stream 3 inlet unit B and part of the hydrogen rich gas 95 is used as fuel in H replacing part of the natural gas fuel such that the resulting flue gas only contains 10% of the carbon contained in the sum of the natural gas feed, stream 1, and natural gas fuel, stream 60.

The SynCOR™ plus 90% Blue shows that the concept can be efficiently used for making blue products. Note that the layout is not optimized for blue but merely shows what happens if the invention is used directly on the selected specific standard SynCOR™ plus case.

The invention provides the possibility to reduce CO₂ content in the flue gas to below 6000 Nm3/h in this specific case. This only requires that the purge gas is send to the ATR instead of the shift and that more hydrogen for fuel, stream 93 or 94, is used as fuel in H.

TABLE 1

| 5000 MTPD | | | SynCOR plus |
|---|---|---|---|
| Methanol | | SynCOR plus | 90% Blue |
| 3000 MTPD Ammo- | Standard Syn- | Purge gas | Purge gas |
| nia | COR plus | to shift | to shift |
| NG total, Nm3/h | 267,200 | 266,300 | 271206 |
| Oxygen, Nm3/h | 143250 | 140,150 | 151708 |
| Captured CO2 | 82486 | 89427 | 109269 |
| Nm3/h | | | |
| Flue gas CO2 | 50826 | 43026 | 28290 |
| Nm3/h | | | |
| Export steam | 81,000 | 79,000 | 92400 |
| Kg/h | | | |

1. Process for the co-production of ammonia and methanol with reduced carbon dioxide emission comprising the steps of
(a) providing a hydrocarbon feed stock;
(b) preheating the hydrocarbon feed stock in a fired heater and/or a reformer waste heat section;
(c) steam reforming the preheated hydrocarbon feed stock in at least one steam reformer to a raw synthesis gas comprising hydrogen and carbon oxides where the module M is <2.05;
(d) splitting the raw synthesis gas into a first and second stream;
(e) passing the first stream of the raw synthesis gas to water gas shift section comprising one or more shift reactors for generating a shifted synthesis gas;
(f) passing the shifted synthesis gas to a carbon dioxide removal section for generating a carbon dioxide depleted synthesis gas;
(g) cleaning the carbon depleted synthesis gas in a cleaning unit to a cleaned synthesis gas comprising hydrogen or hydrogen and nitrogen, optionally adding nitrogen to the cleaned synthesis gas to generate an ammonia synthesis gas with a molar ratio of hydrogen to nitrogen of between 2.9-3.1;
(h) converting the ammonia synthesis gas to ammonia;
and
(i) passing the second stream of the raw synthesis gas to a cooling and water separation section to generate a water depleted synthesis gas;
(j) adding a part of the carbon depleted synthesis gas from step (f) to the water depleted synthesis gas to generate a methanol synthesis gas with a module M>1.95;
(k) converting the methanol synthesis gas in at least one methanol reactor to methanol and withdrawing a raw methanol product and a purge gas stream containing unconverted methanol synthesis gas;
wherein the purge gas stream from step (k) is added to the first stream of the raw synthesis gas upstream to step (e) and/or to the steam reforming in step (c).

2. Process according to claim 1, wherein the steam reforming in step (c) is performed in an autothermal reactor.

3. Process according to claim 2, wherein the autothermal reactor is operated on oxygen.

4. Process according to claim 1, wherein the second synthesis gas stream is adapted to have a module M=(H2-CO2)/(CO+CO2) of 1.8-2.1.

5. Process according to claim 1, wherein the cleaning step (g) of the carbon depleted synthesis gas is conducted in a purification unit selected from: a pressure swing adsorption (PSA) unit, and a cryogenic separation unit.

6. Process according to claim 1, wherein the cleaning step (g) of the carbon depleted synthesis gas is conducted in a nitrogen wash unit.

7. Process according to claim 1, wherein part of the carbon dioxide depleted stream from step (f) is used as fuel in step (b).

8. Process according to claim 1, wherein part of the cleaned gas stream from step (g) is used as fuel in step (b).

9. Process according to claim 1, wherein nitrogen for a nitrogen wash in cleaning step (g) and/or nitrogen for hydrogen/nitrogen molar ratio control of the stream inlet the ammonia synthesis (h) is provided by an air separation unit.

10. Process according to claim 9, wherein the hydrogen/nitrogen molar ratio in the stream to the ammonia synthesis (h) is between 2.9 and 3.1

11. Process according to claim 3, wherein the oxygen is provided form an air separation unit.

12. Process according to claim 1, wherein a part of the carbon dioxide depleted synthesis gas from step (f) and/or part of the cleaned synthesis gas from step (g) is used as fuel in the fired heater rand/or the reformer in step (b).
